(19) United States
(12) Patent Application Publication
(10) Pub. No.: US 2014/0033953 A1
(43) Pub. Date: Feb. 6, 2014

(54) METHOD OF FORMING SYNTACTIC FOAMS

(71) Applicant: Newcastle Innovation Limited, Callaghan (AU)

(72) Inventor: Ho Sung Kim, Kotora (AU)

(73) Assignee: Newcastle Innovation Limited, Callaghan (AU)

(21) Appl. No.: 14/037,713

(22) Filed: Sep. 26, 2013

Related U.S. Application Data
(63) Continuation of application No. 11/995,073, filed on Jan. 8, 2008.

(51) Int. Cl. C08J 9/32

(52) U.S. Cl. CPC C08J 9/32
USPC 106/672; 106/287.35; 106/287.17; 106/206.1; 106/125.1

(57) ABSTRACT

A method of forming a syntactic foam, including the steps of providing a predetermined amount of constituent materials, said constituent materials including hollow microspheres or buoyant particles, a solvent and a first binder; mixing the constituent materials; allowing the constituent materials to separate into at least a phase substantially including said hollow microspheres or buoyant particles and a binder phase; transferring the hollow microsphere/buoyant particle phase into a mould; and forming a syntactic foam in said mould. Also an apparatus for forming the syntactic foam and syntactic foam.

### RELATED APPLICATIONS

This application is a continuation-in-part of co-pending U.S. patent application Ser. No. 11/995,073, filed on Jan. 8, 2008, and which is a national phase of PCT/AU2005/001009, filed on Jul. 8, 2005.

### TECHNICAL FIELD

This invention relates to a method of forming syntactic foams and novel foams made using this method. It has been developed particularly for the manufacture of syntactic foams comprised of hollow microspheres or buoyant particles and a binder.

### BACKGROUND ART

Any discussion of the prior art throughout the specification should in no way be considered as an admission that such prior art is widely known or forms part of common general knowledge in the field.

Known syntactic foams are composite materials comprising a matrix of pre-formed hollow microspheres and a resin binder material. They are characterized by their high mechanical strength and low density. Generally, syntactic foams are used as high-performance, low density packing materials. They are typically used in undersea/marine equipment for deep-ocean current-metering, anti-submarine warfare, sandwich composites, and packing materials in the aerospace and automotive industries.

Various methods of forming syntactic foams have been developed. In any method of forming a syntactic foam, it is critically important to ensure that the hollow microspheres are not subjected to vigorous mixing, which can damage the hollow microspheres and have an adverse effect on the properties of the resulting syntactic foam. It is also important to control the amount of binder material relative to the amount of hollow microspheres so that the hollow microspheres are coated with an appropriate amount of binder. A convenient way to achieve this is under dilute mixing conditions. However, dilute conditions generally require a complex mould design having a means of draining excess solvent from the mould.

Australian patent application no. 51857/01 describes a method of manufacturing syntactic foams in a mould including the steps of combining a polymer, hollow microspheres and a solvent to form a slurry, removing a portion of the slurry through a porous wick and applying conditions which substantially solidify the polymer.

Another important consideration is the cost of presently available syntactic foams. Typically, the hollow microspheres employed are gas filled spheres made of soda-lime-borosilicate glass. The high cost of these glass hollow microspheres, together with the high cost of resin binders (such as epoxy resins) means that presently available syntactic foams are only economically viable in situations where the high-performance properties of syntactic foams justify their cost.

It would be desirable to develop a new process for forming syntactic foams which avoids damage to hollow microspheres, allows adequate control of mixing conditions and which is adaptable to the manufacture of a range of syntactic foam materials. It is also desirable to develop an alternative to existing syntactic foams and methods of producing such foams. Such alternatives can include the use of buoyant particles of various materials in place of hollow microspheres. Throughout this specification the term “buoyant particles” is used to describe particles which will float in the liquid binder phase.

It would also be desirable to develop a new process for forming syntactic foams which allows simple mould design. It would also be desirable to develop a low-cost syntactic foam, which may be used in a variety of industrial applications (e.g. as a building material), where the high cost of presently available syntactic foams cannot be justified.

### SUMMARY OF THE INVENTION

Accordingly, a first aspect of the present invention provides a method of forming a syntactic foam, said method including the steps of:

providing a predetermined amount of constituent materials, said constituent materials including hollow microspheres, a solvent and a first binder;

mixing the constituent materials;

allowing the constituent materials to separate into at least a phase substantially including said hollow microspheres and binder and a binder phase;

transferring the hollow microspheres into a mould; and

forming a syntactic foam in said mould.

A second aspect of the present invention provides an apparatus for forming a syntactic foam, said apparatus including:

a mixer for mixing a predetermined amount of constituent materials, said constituent materials including hollow microspheres, a solvent and a first binder;

a separator in communication with said mixer for separating said constituent materials into at least a phase substantially including said hollow microspheres and a binder phase;

a mould for forming said syntactic foam; and

means for transferring the hollow microsphere phase into said mould.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

Preferably, said transferring step includes extruding or forcing said hollow microsphere phase into said mould.

Preferably, said separating step is performed in a vessel. Preferably, said hollow microsphere phase is forced or extruded into said mould by feeding a liquid into said vessel after said separating step. Preferably, the mixing step is also performed in said vessel.

Preferably, said transferring means includes a conduit fluidly connecting said separator to said mould.

Preferably, said conduit is located at an upper part of said separator.

Preferably, a liquid supply is provided for feeding said liquid into said separator to extrude or force said hollow microsphere phase through said conduit. Preferably, said liquid includes said first binder and said solvent.

Preferably, said separator includes an outlet for draining the remaining constituent material from said separator. Preferably, said outlet is located at a lower part of said separator.

Preferably, the apparatus includes a reservoir for receiving said remaining constituent material.

Preferably, the apparatus includes a conduit fluidly connected to said outlet or said reservoir for returning said remaining constituent material to said mixer.

Preferably, said mixer and said separator are the same.

Preferably, the mould is adapted for draining any excess solvent or first binder.

The method of the present invention may be used with any type of binder material and any type of hollow microsphere. However, it has been developed particularly for forming syntactic foams from cenospheres. Cenospheres are inexpensive, hollow, ceramic microspheres that are a by-product of coal-fired power stations. They are available from several sources, such as Envirospheres®, and have been used as a partial substitute for cement in cementitious compositions. Preferably, the hollow microspheres are buoyant to facilitate the separation step.

Preferably the hollow microspheres are cenospheres.

The method of the present invention is also applicable to buoyant particles, especially buoyant particles having a size of 1 mm to 6 mm in diameter and in particular expanded particles of this size. Therefore, in a third aspect of the invention, there is provided a method of forming a syntactic foam, said method including the steps of:

providing a predetermined amount of constituent materials, said constituent materials including buoyant particles, a solvent and a first binder;

mixing the constituent materials;

allowing the constituent materials to separate into at least a buoyant particle phase substantially including said buoyant particles and a binder phase;

transferring the buoyant particle phase into a mould; and

forming said syntactic foam in said mould.

A fourth aspect of the present invention provides an apparatus for forming a syntactic foam, said apparatus including:

a mixer for mixing a predetermined amount of constituent materials, said constituent materials including buoyant particles, a solvent and a first binder;

a separator in communication with said mixer for separating said constituent materials into at least a buoyant particle phase substantially including said buoyant particles and a binder phase;

a mould for forming said syntactic foam; and

means for transferring the buoyant particle phase into said mould.

Preferably, said buoyant particles have a size of 1 mm to 6 mm in diameter.

Preferably, said buoyant particle phase includes said buoyant particles and said first binder and said binder phase includes said solvent and said first binder.

Preferably the buoyant particles are expanded particles. In one particularly preferred form, the buoyant particles are expanded perlite particles. In another preferred form, the buoyant particles are expanded vermiculite particles. In a further preferred form, the buoyant particles are expanded clay aggregate particles.

Preferably, the buoyant particles have a porous or sponge-like microstructure, or a cellular-like structure.

Preferably, said transferring step includes extruding or forcing said buoyant particle phase into said mould.

Preferably, said separating step is performed in a vessel. Preferably, said buoyant particle phase is forced or extruded into said mould by feeding a liquid into said vessel after said separating step. Preferably, the mixing step is also performed in said vessel.

Preferably, a liquid supply is provided for feeding said liquid into said separator to extrude or force said buoyant particle phase through said conduit. Preferably, said liquid includes said first binder and said solvent.

The preferred features of the first and second aspects of the invention relating to hollow microspheres are equally applicable to the buoyant particles of the third and fourth aspects of the invention, mutatis mutandis. In addition, the third and fourth aspects of invention each have the preferred features of the first and second aspects of the invention not otherwise mentioned above.

In addition, the method of the third aspect of the present invention may be used with any type of binder material and any type of buoyant particle. However, it has been developed particularly for forming syntactic foams from expanded perlite particles. Perlite is a naturally occurring hydrated volcanic glass, and expanded perlite particles are perlite particles that have processed into an expanded form for cellular structure formation. The expansion takes place due to the presence of water in perlite when it is heated to about 427-1093° C. Expanded perlite particles have an excellent potential for building material applications in the first instance, given that they are cheap, light and possess good thermal insulation properties. Also, they are environmentally friendly because they do not react with, or leach into, ground water.

In the building industry, material cost is a driving force in selecting materials as large quantities of materials are required. In applications for interior walls and ceilings, material weight is an important consideration for installation and performance. There have been efforts to reduce the material density in such applications by forming gas bubbles in the case of gypsum but with marginal success. Accordingly, the inventor contemplates that using buoyant particles, especially expanded perlite particles, in the formation of syntactic foams confers significant benefits in being a cheaper alternative to using hollow microspheres while still having lightweight properties.

The solvent used in the present invention may be water or an organic solvent, such as acetone. The choice of solvent will depend on the type of binder used. If the first binder is an organic resin binder (such as amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins or polyurethane resins), then the solvent will typically be an organic solvent, such as acetone. However, if the first binder is an inorganic binder, such as cement, or a natural starch-based organic binder, such as wheat flour or potato starch, then the solvent will typically be water.

In one preferred embodiment of the present invention, the first binder is an inorganic binder. Inorganic hydraulic binders are well known in the art and include calcium-based compositions, such as cements, calcium oxide and gypsum. The preferred inorganic binder used in the present invention is Portland cement. In this preferred embodiment, the hollow microsphere phase includes cenospheres and an amount of binder sufficient to coat the cenospheres. The cenosphere phase is transferred to a mould and allowed to set into a pre-form syntactic foam. Preferably, the pre-form is then subjected to post-wetting in the mould. The post-wetting step improves the mechanical strength of the cement/cenosphere pre-form syntactic foam.

Likewise, in another preferred embodiment of the invention, the buoyant particle phase includes expanded perlite particles and an amount of binder sufficient to coat the expanded perlite particles. The perlite particle phase is transferred to a mould and allowed to set into a pre-form syntactic foam. Preferably, the pre-form is then subjected to post-wetting in the mould. The post-wetting step also improves the mechanical strength of the starch binder/perlite particle pre-form syntactic foam.

Preferably, post-wetting comprises adding a second binder to the pre-form. Preferably, the second binder is an organic binder selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins and polyurethane resins. Epoxy resins, phenolic resins and PVA are particularly preferred second binders in the present invention. Other binding materials, such as hardeners, may also be included with the second binder.

In the syntactic foam-forming step, the second binder is preferably diluted in an organic solvent, such as acetone, and the solution is drawn through the pre-form. This may be achieved by, for example, spraying binder solution over the mould, pouring binder solution over the mould or dipping the mould in binder solution.

Preferably, the mould allows drainage of excess binder and/or solvent from the mould. Drainage of excess binder and/or water is advantageous when fast solidification is desired. The mould may have a porous base or be a bottom-open mould having a porous material, such as a bleeding cloth or paper, underneath the mould.

The syntactic foam-forming step of the present invention may comprise a solidification step, such as a curing and/or a drying step, depending on the type of binder and solvent materials. The solidification step solidifies the binder materials into a syntactic foam. Solidification may comprise heating if the process speed is to be increased.

Preferably, the mixing step is performed in a mixer and the constituent materials are transferred to a separator for the separating step. The mixer is generally a vessel equipped with a mechanical stirrer, such as a paddle stirrer or agitator, which receives the hollow microspheres (or buoyant particles) and a premixed water/binder composition. Other constituent materials (e.g. fillers, plasticisers etc.) may also be added to the mixer at this stage. The mixture may be then transferred to a separator, where the constituent materials separate into at least a phase substantially including the hollow microspheres (or buoyant particles), and a binder phase. It should be readily understood by one skilled in the art that the phase substantially including the hollow microspheres also includes an amount of binder sufficient to coat the microspheres, and will be hereinafter referred to as “the hollow microsphere phase”. Likewise, the phase substantially including the buoyant particles also includes an amount of binder sufficient to coat the particles, and will be hereinafter referred to as “the buoyant particle phase”.

Preferably the constituent materials separate into the hollow microsphere phase (or buoyant particle phase), a solvent phase, and the binder phase. However, the mixing step may be carried out in the separator, if desired. The various phases may separate by settlement in the separator. Generally, the binder forms a sediment at the bottom of the separator and the buoyant hollow microspheres (or buoyant particles) rise to the top of the separator, with the solvent (e.g. water) forming a phase in between the two. Mixing of the constituent materials before separation ensures that hollow microspheres (or buoyant particles) are coated with at least some of the first binder material. The amount of first binder material that coats the hollow microspheres (or buoyant particles), can be controlled by the initial mixing conditions.

The transfer of the hollow microsphere phase (or buoyant particle phase) to the mould may be by any convenient means. For example, the hollow microsphere phase (or buoyant particle phase) may be transferred by simple scooping into the mould. Preferably, the separator is specifically adapted to transfer the hollow microsphere phase (or buoyant particle phase) to the mould by an extrusion or “squeezing” method. In this embodiment, the separator has an inlet and a conduit located at an upper part of the separator. The hollow microsphere phase (or buoyant particle phase) may be extruded or forced (“squeezed”) from the separator via the conduit by introducing liquid into the inlet. The conduit has an outlet for discharging the hollow microsphere phase (or buoyant particle phase) into the mould. Generally, the introduced liquid is a premixed binder/water composition.

In one embodiment, the separator includes an outlet which allows the remaining constituents to be drained from the separator once the hollow microsphere phase (or buoyant particle phase) has been “squeezed” from the conduit outlet. The separator outlet may be located at the lower part of the separator. The remaining constituents may then be recycled back to the mixer for further mixing with a new batch of hollow microspheres (or buoyant particles). In this way, the method and apparatus of a preferred embodiment of the present invention is efficient and cost-effective.

In a further aspect, the present invention provides a syntactic foam obtainable by the method described hereinabove.

In a further aspect, the present invention provides a syntactic foam including hollow microspheres (or buoyant particles), an inorganic binder and an organic binder. In one preferred form, the syntactic foam includes cenospheres, cement and a resinous organic binder. In another preferred form, the syntactic foam includes expanded perlite particles, starch binder and a resinous organic binder.

In a further aspect, the present invention provides a syntactic foam including hollow microspheres (or buoyant particles) and a starch-based binder. In one preferred form, the syntactic foam includes cenospheres and a potato starch or a wheat flour binder. In another preferred form, the syntactic foam includes expanded perlite particles and a potato starch or a wheat flour binder.

Preferably, the ratio of water to starch is between 150:1 and 30:1. Where the starch based binder is wheat flour, the ratio of water to wheat flour is preferably 50:1. Where the starch-based binder is potato starch, the ratio of water to potato starch is preferably 100:1, more preferably 80:1, and even more preferably 30:1.

### BRIEF DESCRIPTION OF THE DRAWINGS

A preferred embodiment of the invention will now be described, by way of example only, with reference to the accompanying drawings in which:

FIG. 1 is a schematic diagram of an apparatus according to the preferred embodiment of the present invention;

FIG. 2 is a schematic diagram illustrating the separation of the constituent materials into a hollow microsphere phase, a water phase and a cement phase;

FIG. 3 is a perspective view of a bottom-open mould used in the preferred embodiment;

FIG. 4 is a cross-sectional view of the separator;

FIGS. 5(a)-(d) show the various stages in the transferral of the hollow microsphere phase into the mould from the separator, and

FIG. 6 is a graph showing the mass reduction per unit volume versus drying time for different perlite particle sizes.

### DETAILED DESCRIPTION OF THE INVENTION

### Syntactic Foam Formed By Post-Wetting a Pre-form

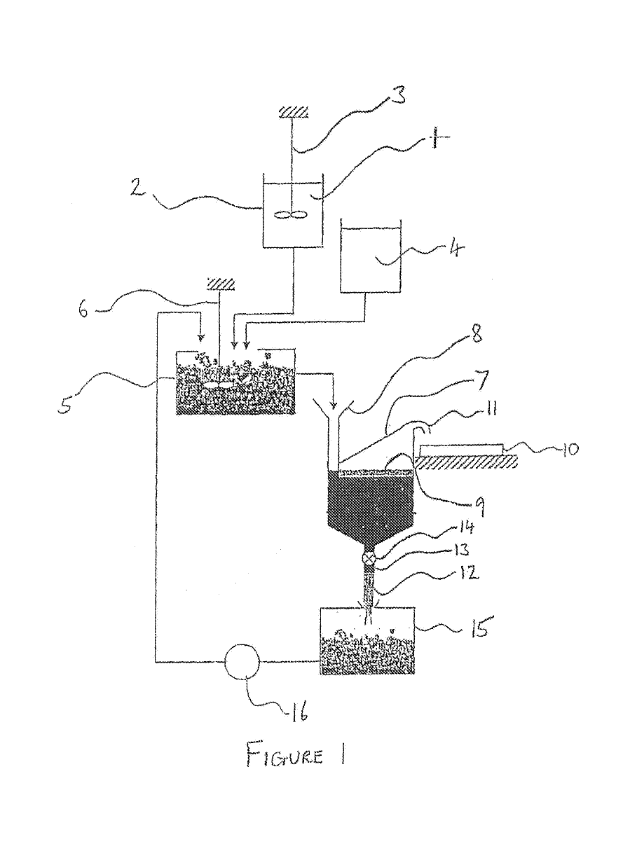

Referring to FIG. 1, a Portland cement and water composition 1 are premixed in premixer 2, by means of a mechanical stirrer 3. The composition 2 is admixed with cenospheres 4 in a mixer 5. These constituent materials are mixed together using a mechanical stirrer 6. The constituent materials in the mixer 5 are shown in Table 1.

TABLE 1

| Materials | Parts by weight |
|---|---|
| Cement (Blue Circle, Mix n' Fix - Rapid set cement) | 53 |
| Cenospheres (Bayswater power station) | 13 |
| Water | 33 |

After mixing, the constituent materials are transferred to a separator 7 via funnel inlet 8. The constituent materials settle into three phases—a wet cenosphere phase 9 (that is, a phase made of cenospheres coated with cement), a water phase 19 and a cement phase 20. The cenospheres, being buoyant in the cement and solvent mixture, rise to the upper part of the separator 7 to form the wet cenopshere phase 9. The cement phase 20 forms a sediment towards the lower part of the separator 7 with the water phase 19 in between the two phases. The upper wet cenosphere phase 9 is transferred to a mould by conduit 11 at the upper part of the separator 7. The open end of the conduit 11 forms an outlet to discharge the wet cenosphere phase 9 into the mould 10. Excess cement/water 12 is drained from the separator by an outlet 13 at the lower part of the separator, the outlet 13 having a tap 14. The excess cement/water 12 drains into a recycling reservoir 15, where it is pumped back to the mixer 5 via pump 16.

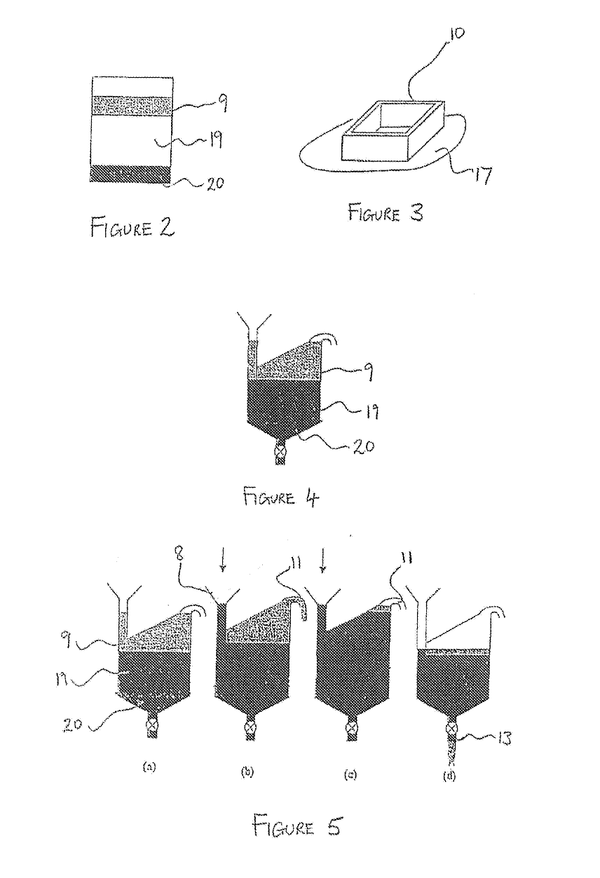

The mould 10 is shown in more detail in FIG. 3. The mould 10 takes the form of a bottom-open mould having a porous paper base 17.

The separation step is shown in more detail in FIGS. 2 and 4. FIGS. 2 and 4 show how the constituent materials separate into the wet cenosphere phase 9, the water phase 19 and the cement phase 20.

The squeezing and draining steps are shown in more detail in FIG. 5. In FIG. 5(a), phase separation is shown in which the cement sediment 20 is at the bottom of the separator, the wet cenosphere phase 9 is at the top of the separator and the water phase 19 is in the middle. In FIG. 5(b), a mixture of water and cement is fed into the inlet funnel 8, which extrudes or forces (“squeezes”) the wet cenosphere phase 9 through the conduit 11 for moulding. In FIG. 5(c), most of the wet cenosphere phase 9 has been transferred for moulding. In FIG. 5(d), the remaining constituent materials (the water phase 19 and the cement phase 20) are drained from the separator via second outlet 13 for remixing.

Returning now to the syntactic foam-forming step, the wet cenosphere phase 9 is allowed to set in the mould 10 for two days to form a pre-form syntactic foam. Excess water and cement drains through the porous paper base 17 as the pre-form syntactic foam sets. After two days, the pre-form was subjected to post-wetting. The constituent materials in the post-wetting solution are shown in Table 2.

TABLE 2

| Materials | Parts by weight |
|---|---|
| Epoxy and hardener (West System, Epoxy 105 and Slow | 11 |
| Hardener 206 - mixture ratio 5:1 volume) | |
| Acetone | 89 |

The post-wetting solution was poured onto the moulded syntactic foam and excess solvent drained through the porous paper base 17. Following post-wetting, there was provided a syntactic foam which is lightweight, durable and has high-mechanical strength. Furthermore, due to the use of inexpensive cenospheres and limited amounts of resin binder and acetone, the syntactic foam was inexpensive to produce.

Syntactic Foam Formed without Post-Wetting

The above procedure was followed, but without the post-wetting step. In the following examples, the diluted binders were potato starch (Tung Chun Soy & Canning Company, Hong Kong), wheat flour (Home Brand, Plain Flour) and PVA (Selleys Aquadhere Polyaliphatic Cross-Linking PVA). The constituent materials mixed together in the mixer 5 are shown in Table 3.

TABLE 3

| | | | Wheat | Potato | |
|---|---|---|---|---|---|
| Materials | Water | PVA | flour | starch | Microspheres used |
| Mass | 50 | | 1 | | Cenosphere |
| ratios | 80 | | | 1 | Cenosphere |
| | 150 | | | 1 | SLG Envirosphere ® |
| | 20 | 1 | | | SLG Envirosphere ® |
| | 20 | 1 | | | SLG Envirosphere ® |
| | 30-100 | | | 1 | SL500 Envirosphere ® |

In the case of the three examples employing wheat flour or potato starch, gelatinization (by heating for 10 minutes in water) was conducted before the binders were mixed with the hollow microspheres. The gelatinization can be conducted after moulding as part of the drying process.

The method of the preferred embodiments of the invention described above equally apply to the production of syntactic foams that use buoyant particles instead of hollow microspheres, especially buoyant particles having a diameter size of 1 mm to 6 mm. It has been discovered that expanded particles of this diameter, like expanded perlite, are able to be used in syntactic foams that confer similar loading characteristics as syntactic foams made with hollow microspheres but also offer the additional advantage of being less expensive than hollow microspheres and providing lower density compared to other similar building materials. This is primarily due to the buoyant particles facilitating separation of the buoyant particle phase from the binder phase in the separating step. As such, the steps of the method will not be repeated as they are the same but for the use of expanded perlite particles instead of cenospheres.

### EXAMPLES

The application of the invention to buoyant particles will further be described with reference to the following examples set out below.

### Expanded Perlite Particles

In each of the examples, expanded perlite particles (P400) were obtained from Ausperl Pty Ltd and were classified into five different size groups using custom made sieves. Six different opening sizes for the sieves were made using drill bits with diameters of 1, 2, 3, 4, 5 and 6 mm respectively. The perlite particles obtained through sieving were therefore in ranges between 1 and 2 mm, 2 and 3 mm, 3 and 4 mm, and 5 and 6 mm, and they will be hereinafter referred to as Size 1-2, Size 2-3, Size 3-4, Size 4-5, and Size 5-6, respectively.

Particle densities of the expanded perlite particles were measured using an air pycnometer (Micrometrics AccuPyc 1330) and averages from three respective measurements for each sample are listed in Table 3. Bulk densities for the same particles were also measured using a tapper for 500 taps and a glass cylinder (100 ml, 28 mm diameter) and listed in Table 3. All the particle densities are in a range between 0.49 g/cm³ and 0.59 g/cm³. Both particle and bulk densities appear to marginally increase with increasing particle size.

TABLE 3
Expanded perlite particle and bulk densities

| Size of Perlite | Bulk Density (g/cm³) |
|---|---|
| Size 1-2 | 0.08434 |
| Size 2-3 | 0.0853 |
| Size 3-4 | 0.0898 |
| Size 4-5 | 0.1073 |
| Size 5-6 | 0.0966 |

### Example 1

A batch of potato starch particles (Tuan Chun Soy and Canning Company, Hong Kong) was used for making gelatinized starch binder. Also, starch particles were measured for particle and bulk densities to be 1.5 g/cm³ and 0.85 g/cm³ respectively.

The gelatinization process was conducted by mixing potato starch particles in water and then heating for 20 minutes at 65-70° C. with continuous stirring. The obtained binder was cooled to room temperature with further stirring to avoid any kind of non-homogeneous formation.

Dry perlite particles were poured into a prepared binder of the mixing container and followed by stirring/tumbling (about 300 strokes). The mixing container was left until perlite particles float to the surface and starch settles down. As a result, three different phases were formed in the mixing container: top phase made of perlite particles and starch binder, middle phase made of water, and bottom phase made of gelatinized starch and water. The top phase was formed immediately but the bottom two phases were formed after several hours following the separation into two phases. It is a wet mix as distinct from slurry in the presence of buoyancy of perlite particles.

The mixture was then separated in accordance with the method of the preferred embodiment as described above, where the buoyant particle phase was poured into rectangular moulds.

### Example 2

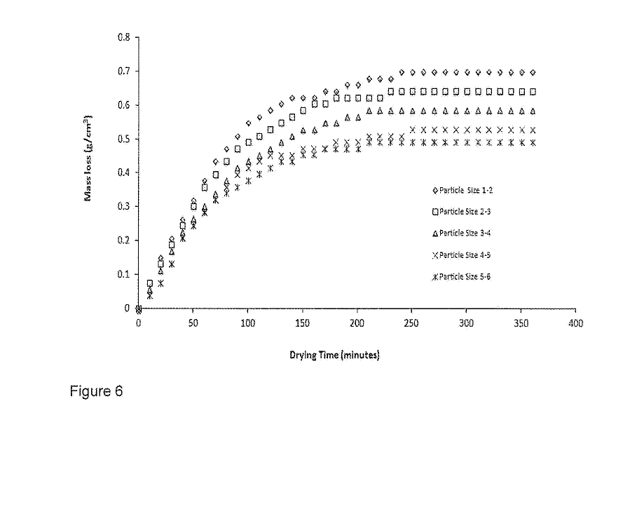

A wet mix of perlite particles and binder was prepared as described in Example 1 and poured into rectangular moulds. Drying of the wet-mix after moulding into rectangular moulds was conducted in an oven at 80° C. As a result, mass reduction per unit volume versus drying time for different perlite particle sizes was obtained for a starch to water ratio (3g starch in 100 ml water) and illustrated in FIG. 6. It verifies that the binder content in the wet-mix depends on the perlite particle size—the smaller particle sizes the larger binder content due to the capillary action of binder.

### Example 3

The wet mix can be allowed to dry to a stage where the wet-mix was still reversibly deformable and can be unmoulded without disturbing its structural shape. At this stage, the wet mix may be suitable for the preparation of mechanical testing samples such as core of sandwich composites (without facing skins).

The wet mix can also be allowed to dry to a “final” stage where the binder is solidified and therefore if cracking occurs due to external forces, its repair is not possible without extra binder.

A batch of wet-mix of perlite particles and binder was prepared as described in Example 1, but with a starch to water ratio of (2.5 g starch/100 ml) in a drying mould at 80° C. was prepared and measurements were conducted to compare these two stages. It was found that as the perlite particle size increases of the wet-mix, the drying time decreases. Consequently, the wet mix can be moulded is less time for larger perlite particles.

### Example 4

Size 3-4 expanded perlite particles were chosen and three different volumes of a wet mix of the binder coated perlite particle phase were prepared for pouring into cylindrical moulds. The cylindrical moulds were in three different sets of dimensions (a constant diameter of 30 mm with 50 mm, 95 mm or 125 mm in height) for the three different volumes of wet-mix respectively. The larger mould the higher density can be produced for a constant final volume with 32 mm high and 30 mm in diameter (ASTM C365/C365M—Standard test method for flatwise compressive properties of sandwich cores). Each moulding was densified to have a range of different densities. A Shimadsu universal testing machine was used for densification at a crosshead speed of 10 mm/min.

Compressive tests of several examples of syntactic foam made in accordance with the preferred embodiment of the invention were conducted at a crosshead speed of 10 mm/min. It was demonstrated that the compressive strength of the syntactic foams was linear and that the compressive strengths at a density of about 0.3 appears to be comparable with those of foamed gypsum which has a range of 0.41-1.8 MPa at a density range of 0.7-0.9 g/cc. Therefore, syntactic foams made in accordance with the invention are adaptable for practical products with the benefit of a much lower density.

It was also found that syntactic foam made of expanded perlite particles in and starch in accordance with the invention had load-displacement curves that were similar to the load-displacement curves of syntactic foam made of cenospheres and starch. Hence, syntactic foams made in accordance with the preferred embodiment and examples of the invention have similar load-displacement properties of syntactic foams made with microspheres.

In yet another example, the boards were manufactured with syntactic foams made in accordance with the method of the invention having paper skins. These syntactic foams had a lower density than conventional gypsum boards.

Other examples of syntactic foams were made in accordance with the invention using perlite particles and sodium silicate or epoxy as the binder.

While the preferred embodiments of the invention have been described as using expanded perlite particles to produce syntactic foam, it will be appreciated that other expanded particles may be used, such as expanded clay aggregate and expanded vermiculite and other particles capable of expansion. Also, other buoyant particles can be used in the invention, including particles that have a porous or sponge-like microstructure, or a cellular-like structure.

These examples demonstrate the versatility of the method of the preferred embodiment of the present invention, especially in providing a method which can be used to give syntactic foams from inexpensive materials.

It will of course be appreciated that the present invention has been demonstrated by way of example only and that modifications of details may be made within the scope of invention.

Claimed is:

1. A method of forming a syntactic foam, said method comprising the steps of:
providing a predetermined amount of constituent materials, said constituent materials including buoyant particles, a solvent and a first binder;
mixing the constituent materials;
allowing the constituent materials to separate into at least a buoyant particle phase including said buoyant particles and said first binder and a binder phase including said solvent and said first binder;
transferring the buoyant particle phase into a mould; and
forming a syntactic foam in said mould.

2. The method of claim 1, wherein said transferring step includes extruding or forcing said buoyant particle phase into said mould.

3. The method of claim 1, wherein said separating step is performed in a vessel, and said buoyant particle phase is forced or extruded into said mould by feeding a liquid into said vessel after said separating step.

4. The method of claim 1, wherein said buoyant particles have a size of 1 mm to 6 mm in diameter.

5. The method of claim 1, wherein the buoyant particles are expanded particles.

6. The method of claim 5, wherein said expanded particles comprise at least one of expanded perlite particles, expanded vermiculite particles and expanded clay aggregates.

7. The method of claim 1, wherein the buoyant particles have a porous or sponge-like microstructure, or a cellular-like structure.

8. The method of claim 1, wherein said separating step and said mixing step are performed in a vessel.

9. The method of claim 1, wherein the mixing step is performed in a mixer, and the constituent materials are transferred to a separator for performing the separating step.

10. The method of claim 1, including the step of draining any excess solvent or first binder from said mould.

11. The method of claim 1, wherein the syntactic foam-forming step includes post-wetting of a pre-form formed in said mould.

12. The method of claim 11, wherein said post-wetting includes adding a second binder to said pre-form.

13. The method of claim 12, wherein the second binder is added by drawing a solution of the second binder through the pre-form.

14. The method of claim 13, wherein said solution is an acetone solution.

15. The method of claim 12, wherein said second binder is an organic binder.

16. The method of claim 1, wherein the syntactic foam-forming step includes a solidification step, said solidification step including heating.

17. The method of claim 1, wherein after said transferring step the remaining constituent materials are returned to said mixing step.

18. The method of claim 1, wherein the solvent is water or an organic solvent.

19. The method of claim 1, wherein the first binder is an organic binder.

20. The method of claim 19, wherein said first binder is a starch-based binder.

21. The method of claim 20, wherein said method includes the step of gelatinising said starch-based binder.

22. The method of claim 21, wherein said gelatinising step is performed prior to said mixing step.

23. The method of claim 21, wherein said gelatinising step is performed after said foam-forming step.

24. The method of claim 20, wherein the starch-based binder is wheat flour or potato starch.

25. The method of claim 1, wherein the first binder is an inorganic binder.

26. The method of claim 25, wherein the solvent is water and the first inorganic binder is cement.

27. The method of claim 15, wherein said organic binder is selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins, polyurethane resins, wheat flour and potato starch.

28. The method of claim 19, wherein said organic binder is selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins, polyurethane resins, wheat flour and potato starch.

29. An apparatus for forming a syntactic foam, said apparatus including:
a mixer for mixing a predetermined amount of constituent materials, said constituent materials including buoyant particles, a solvent and a first binder;
a separator in communication with said mixer for separating said constituent materials into at least a buoyant particle phase including said buoyant particles and said first binder and a binder phase including said solvent and said first binder;
a mould for forming said syntactic foam; and
means for transferring the buoyant particle phase into said mould.

30. A syntactic foam obtained by the method of claim 1.

31. A syntactic foam obtained from the apparatus of claim 29.
